(19) United States
(12) Patent Application Publication
(10) Pub. No.: US 2003/0023509 A1
(43) Pub. Date: Jan. 30, 2003

(54) Method for selecting and paying for items with a mobile terminal

(76) Inventor: Ralf Rammig, Munchen (DE)

Correspondence Address: LERNER AND GREENBERG, P.A., PATENT ATTORNEY'S AND ATTORNEYS AT LAW, Post Office Box 2480, Hollywood, FL, 33022-2480, US

(21) Appl. No.: 10/177,512

(22) Filed: Jun. 21, 2002

Related U.S. Application Data
(63) Continuation of application No. PCT/DE00/04220, filed on Nov. 27, 2000.

(30) Foreign Application Priority Data
Dec. 21, 1999 (DE) 199 61 793.7

(51) Int. Cl. G06F 17/60

(52) U.S. Cl. 705/26

(57) ABSTRACT

The conventional method of operating a vending machine is supplemented by providing a connection that is not established via a mobile radio network and the switching centers and control devices connected therewith. An additional, direct connection between the mobile terminal (i.e., the consumer/subscriber) and the vending machine is provided. The connection can for example be established via Bluetooth or IrDa standard.

### CROSS-REFERENCE TO RELATED APPLICATION

This application is a continuation of copending International Application No. PCT/DE00/04220, filed Nov. 27, 2000, which designated the United States and which was not published in English.

### BACKGROUND OF THE INVENTION

1. Field of the Invention

The use of mobile telephones has grown continuously in the last few years. Many telephone customers now have a mobile terminal for business and/or private use in addition to their conventional telephone connection. In order to acquire even more customers and to make using mobile telephones even more attractive, new telecommunication services are always being provided by network operators. A significant aspect of this is also the billing, as customers can be charged for services offered by means of a large number of parameters (for example the time, the current capacity utilization etc.). There has also been particular success with what are referred to as “prepaid cards” and a telephone card application wherein credit is paid into an account (this can also be located on a chip card at the terminal) of the subscriber and the charges incurred by the subscriber can then be deducted from it.

International PCT publication WO 98/11519 discloses a method for “Cashless Payment With a Mobile Telephone.” The method makes it possible to use a mobile telephone which contains a multifunctional chip card to set up a connection to a business terminal via a mobile network. After a credit worthiness check, transactions involving even relatively large amounts of money can then be carried out. The method runs completely via the mobile radio network and is restricted to the description of the actual payment procedure which is processed by means of a credit card center.

German published patent application DE 198 39 178 A1 (not prior art) also describes a communication system for supporting the transfer of services and/or goods. An order is submitted to a call center via a mobile telephone, a receipt is passed on from the call center to the mobile radio system and the person making the order then enters his authorization to obtain the goods or services at his customer terminal.

It has also become known heretofore that goods and services extending beyond telephone services can also be billed for by way of the telephone bill. Many goods and services can now already be “bought” at vending machines; this service extends for example from fuel at a gas station (previously using charge card or credit card) to public transport tickets, business cards, passport photos and stamps, for usually very small amounts of money. A further known example—found in Europe—is a vending machine for canned drinks, as introduced by the Norwegian mobile radio operator Netcom in co-operation with the drinks manufacturer Ringes and Siemens wherein the subscriber uses her mobile telephone to dial the “call number” of the vending machine and requests the desired drink. The cost of the drink is then debited via the telephone bill.

FIG. 1 illustrates a system such as one which currently technically achieves this object. The item W to be ordered in the vending machine A is selected manually by inputting a numerical sequence (a “call number” of the vending machine, which may actually be quite long) into the mobile terminal KE (11). The call is directed via the network IN (a mobile radio network with an IN system, i.e. an additional architecture according to ITU-T Q.1200 et seq.) and an authorization check on the subscriber is carried out there (12).

Then, in the case of a successful check, the operator console of the vending machine is released (13), and the subscriber can make the selection at the vending machine. The item is then output by the vending machine (14). This “call” is billed specifically (“Premium Rate”) (15). If another payment method is agreed, the fee is deducted, for example, from a debit card or a prepaid account.

However, this method described above is very rigid. The items contained in the vending machine must all have the same price because a “call” at the vending machine is billed on a strict basis. It is possible to select the desired article by means of a terminal only if a separate call number is entered for each of the articles contained in the vending machine.

### SUMMARY OF THE INVENTION

It is accordingly an object of the invention to provide a method of selecting and paying for goods with a mobile terminal, which overcomes the above-mentioned disadvantages of the heretofore-known devices and methods of this general type and which specifies an improved method for purchasing or selling goods.

With the foregoing and other objects in view there is provided, in accordance with the invention, a method of selling items in a vending machine, which comprises:

establishing a first connection, not via a mobile radio network, to enable a subscriber to select an item at the vending machine from a mobile terminal;

addressing the vending machine with the mobile terminal of the subscriber by way of a second connection via a mobile radio network;

performing an authorization check for the second connection in the network;

after a successful authorization check, enabling the vending machine to output the selected item.

With the above and other objects in view there is also provided, in accordance with the invention, a method of purchasing an item from a vending machine using a mobile terminal, which comprises:

setting up a first connection from the first terminal to the vending machine via an interface;

making a selection at the vending machine by way of the first connection;

setting up a second connection from the terminal to the vending machine via a mobile radio network;

performing an authorization check in the mobile radio network; and

outputting the selected item with the vending machine.

The previously customary method for operating a vending machine is supplemented by a further connection, referred to below as “first connection”, which is not conducted via the mobile radio network which is normally used, or via the switching offices and control offices contained in it. It is implemented by means of an additional direct connection between the terminal (and thus the purchasing subscriber) and the vending machine. While the authorization checking and the debiting of the subscriber's account with the price of the item continues to be conducted via the network, the selection of the item is controlled via the first connection, and thus directly. The abovementioned disadvantages are avoided with the method according to the invention. The flexibility of the items offered can be increased, for example by new offers, different selling prices and selling prices which can be configured in a particularly flexible way for the different items. Furthermore, articles which are temporarily unavailable (because they are sold out, for example) can be dynamically excluded from the selection and offered again once restocking has taken place. This increases the convenience for the subscriber because a new number does not have to be laboriously input every time.

In accordance with an added feature of the invention, payment for the item is effected via a billing mechanism used in the mobile radio network. The payment for the item can thus be effected together with a billing of the second connection in the mobile radio network.

In accordance with an additional feature of the invention, the first connection is a wireless connection directly between the terminal and the vending machine via a transmission interface. Preferably, the transmission link is according to the Bluetooth standard or via an IrDA link.

In accordance with another feature of the invention, the selection at the vending machine is done with menu-prompted selections. Advantageously, there are offered for selection only those items which are available in the vending machine at a time of the selection. The sales and vending process may be supported with announcements.

In accordance with a further feature of the invention, there is transmitted, by way of the first connection, information containing data about the items offered and/or a price of the items.

In accordance with a concomitant feature of the invention, the information transmitted by way of the first connection contains a call number or parts of a call number with which the vending machine or the selected item in the vending machine is selected with a connection via the mobile radio network.

The more recent mobile terminals are now equipped with additional transmission interfaces. This is, for example, an infrared interface such as in the new Siemens “S25” which can be used to synchronize the terminal with an electronic diary (referred to as hand held or even palm top), to send and receive faxes and exchange other data. A known standard is Bluetooth, which is suitable for short distances of 10 cm (4 inches) up to 100 meters (330 ft). The transmission takes place at 2.4 GHz in the ISM (Industrial Scientific Medical) band. Further information can be found on the official homepage (http://www.bluetooth.com). A suitable alternative to this is IrDA (Infrared Data Association), currently with three communication standards using infrared. Here, the range is up to 1 meter and the transmission rate between 9600 bps to 16 Mbps. (See also in this respect http://www.irda.org). The execution of the concept of the invention is however not restricted to these two standards. The transmission of data over the first connection contains data relating to the items offered in the vending machine, including further data such as the price. This selection can then be shown on the display of the terminal, preferably with menu prompting, so the subscriber can easily make his selection. After the selection has been made, the vending machine is actuated by the terminal by means of the first connection and the control is triggered in the network by means of a second connection. The control of the vending machine will continue to be performed through the network (which thus carries out the identification of the subscriber and ensures security)—possibly also the activation of an item-outputting compartment—but the release is carried out via the network. After the selection of the items by means of the menu, the network connection to the vending machine is set up.

Other features which are considered as characteristic for the invention are set forth in the appended claims.

Although the invention is illustrated and described herein as embodied in a method for selecting and paying for items with a mobile terminal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram illustrating an example of the prior art as described above;

FIG. 2 is a diagram showing a solution according to the invention contrasting with FIG. 1; and

FIG. 3 is a schematic diagram showing a call scenario.

### DESCRIPTION OF THE PREFERRED EMBODIMENTS

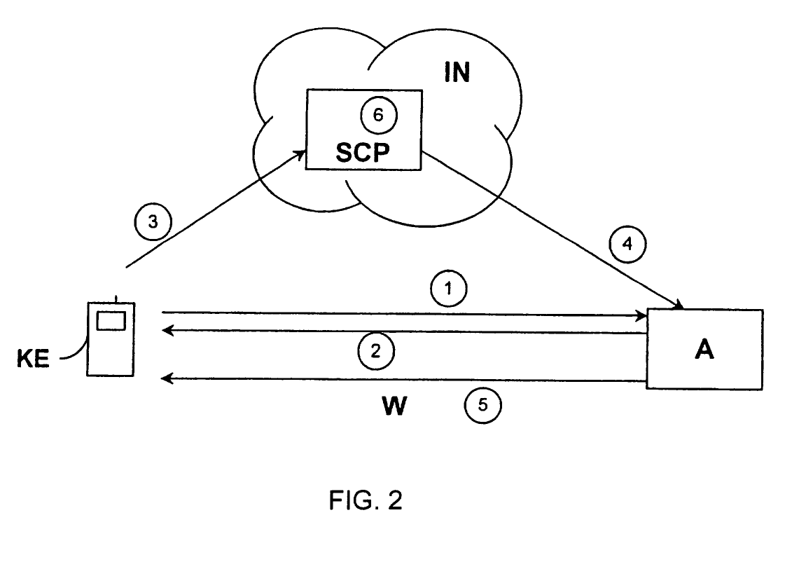

Referring now once more to the figures of the drawing in detail, and particularly to FIG. 2 thereof, there is shown the procedure according to the invention in a simplified representation.

The subscriber first sets up a connection to the vending machine using his terminal KE by means of a direct communications channel, for example Bluetooth (1). The subscriber can then select the desired item by means of a menu selection (2). By means of this connection, the ordering of the item can be initiated in that the subscriber selects, for example, “OK” by means of the menu in his terminal and thus enables the payment of the sum indicated. A first connection is set up here to a central entity SCP in the mobile radio network (3), to be more precise a voice channel SSP, and from this SSP a signaling connection is then set up to the SCP. Authorization checking of the subscriber is carried out and the order is then passed on to the vending machine (4). This call number may have previously also been transmitted together with the information relating to items and prices during the data transmission so that the subscriber no longer has to laboriously input this information.

The item is then released by the vending machine (5), and the billing of the costs takes place in accordance with the customary billing procedures in the mobile radio network (6) by means of the telephone bill or by debiting from the prepaid account.

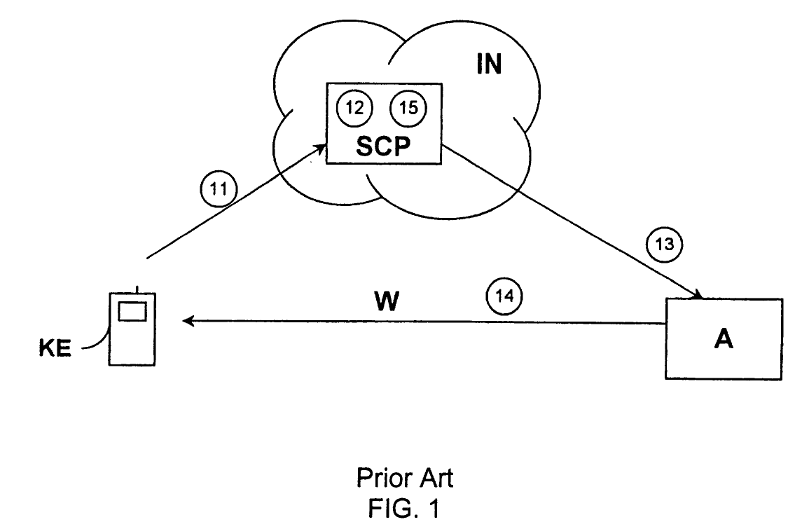

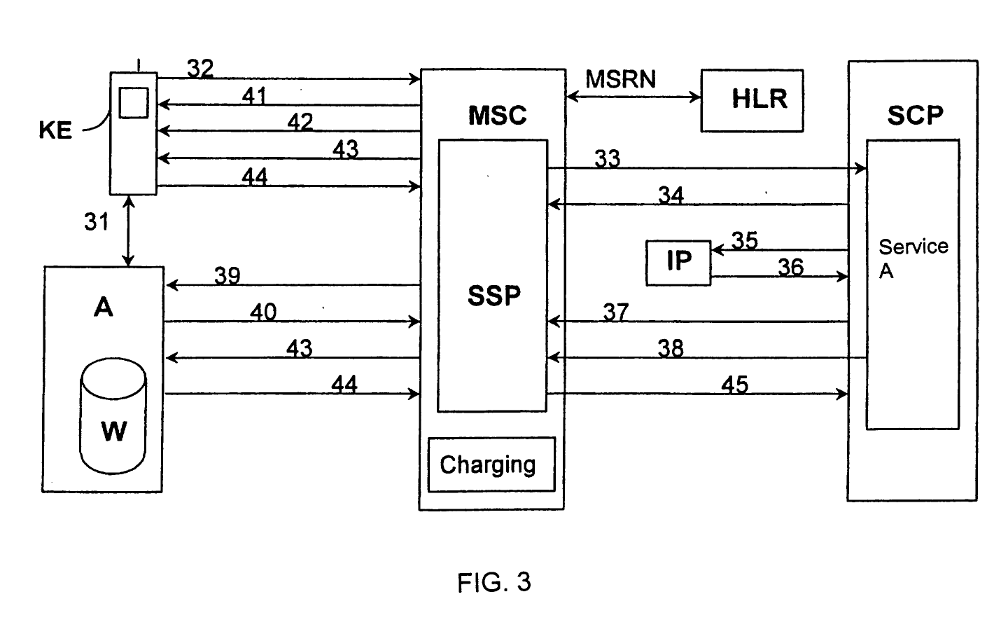

FIG. 3 shows the scenario of a purchase once more in more detail. In addition to the components vending machine A (with item W), mobile terminal KE and the service control point SCP already represented in FIGS. 1 and 2, the mobile switching center MSC (with the component service switching center SSP and the billing component Charging) as well as a further entity, which can for example make announcements in the network (IP, Intelligent Peripheral) are also illustrated here. There is also a subscriber register HLR (Home Location Register). The network components SSP, SCP, IP are based here on the technology of intelligent networks which constitute an architecture for implementing so-called added value services in a telecommunications network. This technology is described in the ITU-T Standards Q.1200 et seq. However, this restriction is not essential to the invention.

The subscriber uses his terminal KE to establish a direct connection 31 by means of the Bluetooth or IrDA technology described further above, or any other suitable wireless transmission technology. The user selects the desired drink W and enters his OK for the purchase. As a result, a call is triggered, 32 SETUP (A-Party No., B-Party No.), from the terminal via the mobile radio network. The MSRN (mobile station roaming number) of the subscriber is communicated to the SSP via the HLR. The sales service (service A) in the SCP (of the service center which performs and monitors the administration and execution of the services) is triggered by the call number, 33: IDP (Service A, A-Party, B-Party). If an announcement is to be played (for example advertisement), the SSP is requested to pass on the message to the IP, 34: ConnectToResource. The IP is requested to play the announcement, 35. After the termination, it signals this back, 36: SpecResourceReport. The SSP then terminates the passing on of the connection to the IP, 37: DisconnectForwardConnection. Service A can now carry out authorization checks: Whitelist and Blacklist entries are now checked: is a subscriber approved for this service or excluded from this service? If the subscriber is rejected as a result of this check, a corresponding announcement can be played on the device KE. The selected Premium Rate Call Number of the vending machine (B-Party) is now converted into a real call number and the SSP is requested to set up the connection, 38: CONNECT (B-Party'). A timer may optionally be set which guarantees that the connection has a minimum duration in order to protect the billing. The call is passed on in the normal way, 39: SETUP, the roaming number MSRN also being interrogated in the process. The connection set-up attempt is signalled to the subscriber on his terminal, 41: ALERTING. The vending machine responds to the SET-UP with a CONNECT 40, and a connection is first established via the mobile radio network, 42: CONNECT. After the time has expired, the connection is aborted, 43: REL (Release), 44: RLC (Release Complete). The connection release in conjunction with the billing is signaled to the service center at the end, 45: ApplyChargingResult (possibly with forcedRelease).

I claim:

1. A method of selling items in a vending machine, which comprises:
establishing a first connection, not via a mobile radio network, to enable a subscriber to select an item at the vending machine from a mobile terminal;
addressing the vending machine with the mobile terminal of the subscriber by way of a second connection via a mobile radio network;
performing an authorization check for the second connection in the network;
after a successful authorization check, enabling the vending machine to output the selected item.

2. The method according to claim 1, which comprises paying for the item via a billing mechanism used in the mobile radio network.

3. The method according to claim 1, wherein the first connection is a wireless connection directly between the terminal and the vending machine via a transmission interface.

4. The method according to claim 3, wherein the first connection is a transmission link selected from the group consisting of a Bluetooth link and an IrDA link.

5. A method of purchasing an item from a vending machine using a mobile terminal, which comprises:
setting up a first connection from the first terminal to the vending machine via an interface;
making a selection at the vending machine by way of the first connection;
setting up a second connection from the terminal to the vending machine via a mobile radio network;
performing an authorization check in the mobile radio network; and
outputting the selected item with the vending machine.

6. The method according to claim 5, wherein the first connection is a transmission link selected from the group consisting of a Bluetooth link and an IrDA link.

7. The method according to claim 5, which comprises performing the selection step at the vending machine by way of the first connection with menu-prompted selections.

8. The method according to claim 7, which comprises offering for selection only those items which are available in the vending machine at a time of the selection.

9. The method according to claim 7, which comprises supporting the sales process with announcements.

10. The method according to claim 5, which comprises effecting payment for the item together with a billing of the second connection in the mobile radio network.

11. The method according to claim 5, which comprises transmitting by way of the first connection information containing data selected from the group consisting of items offered and a price of the items.

12. The method according to claim 5, wherein the information transmitted by way of the first connection contains a call number or parts of a call number with which the vending machine or the selected item in the vending machine is selected with a connection via the mobile radio network.
